(19) United States
(12) Patent Application Publication
(10) Pub. No.: US 2009/0268300 A1
(43) Pub. Date: Oct. 29, 2009

(54) LIGHT SHADE FOR DISPLAY PANEL

(75) Inventors: Lung Dai, Tu-Cheng (TW); Wang-Chang Duan, Shenzhen City (CN)

Correspondence Address: PCE INDUSTRY, INC.;ATT. Steven Reiss, 288 SOUTH MAYO AVENUE, CITY OF INDUSTRY, CA, 91789, US

(73) Assignees: HONG FU JIN PRECISION INDUSTRY (ShenZhen) CO., LTD., Shenzhen City (CN); HON HAI PRECISION INDUSTRY CO., LTD., Tu-Cheng (TW)

(21) Appl. No.: 12/346,869

(22) Filed: Dec. 31, 2008

(30) Foreign Application Priority Data
Apr. 24, 2008 (CN) 200810301294.6

(51) Int. Cl. G02B 27/00

(52) U.S. Cl. 359/601; 359/611

(57) ABSTRACT

A light shade is provided for partially blocking ambient light from a display panel. The light shade includes a shade portion and a position portion. The shade portion is configured for partially blocking the ambient light. The positioning portion is formed on a side of the shade portion. The shade portion includes at least one baffle. The positioning portion is configured for attaching the shade portion to the display panel. The positioning portion comprises a track and a plurality of blocks formed on an inner side and an outer side of the track. When the shade portion is attached to the display panel, the at least one baffle engages with at least one side of the display panel.

### BACKGROUND

1. Field of the Invention

The present disclosure generally relates to a light shade for a display panel.

2. Description of related art

Electronic devices, such as televisions and computers, use display screens to output video or image information. Flat panel displays, such as liquid crystal displays (LCDs) and plasma display panels (PDPs) are widely used for their portability. These portable display panels are always taken outdoors or to other places with bright ambient light. In these circumstances, because of the light contrast between the display screen and the ambient brightness, the visibility of the images or videos displayed in these portable display panels are decreased.

Therefore, a light shade for a display panel is needed in the industry to address the aforementioned deficiency.

### BRIEF DESCRIPTION OF THE DRAWINGS

FIG. 1 is a schematic assembled diagram showing an electronic device using a light shade in accordance with an exemplary embodiment.

FIG. 2 is a schematic partially disassembled diagram showing the electronic device.

FIG. 3 is a schematic diagram showing the light shade.

### DETAILED DESCRIPTION

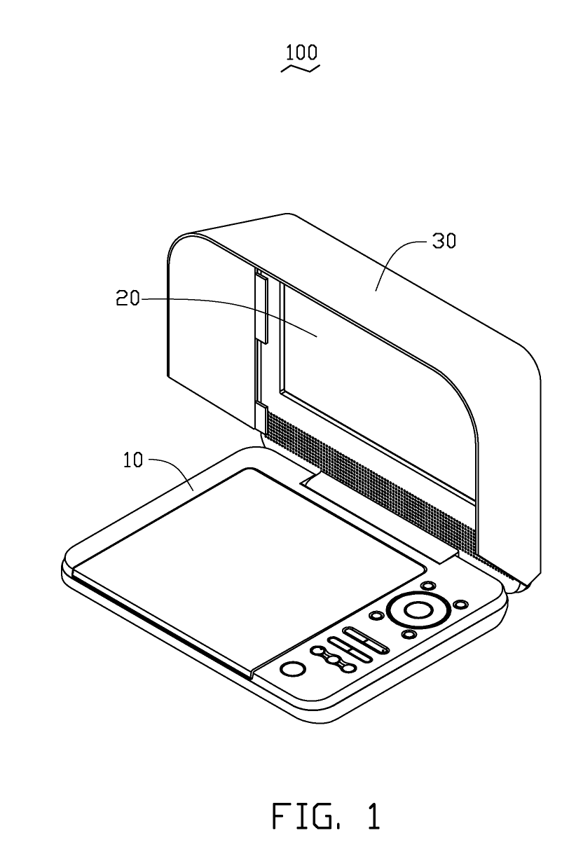

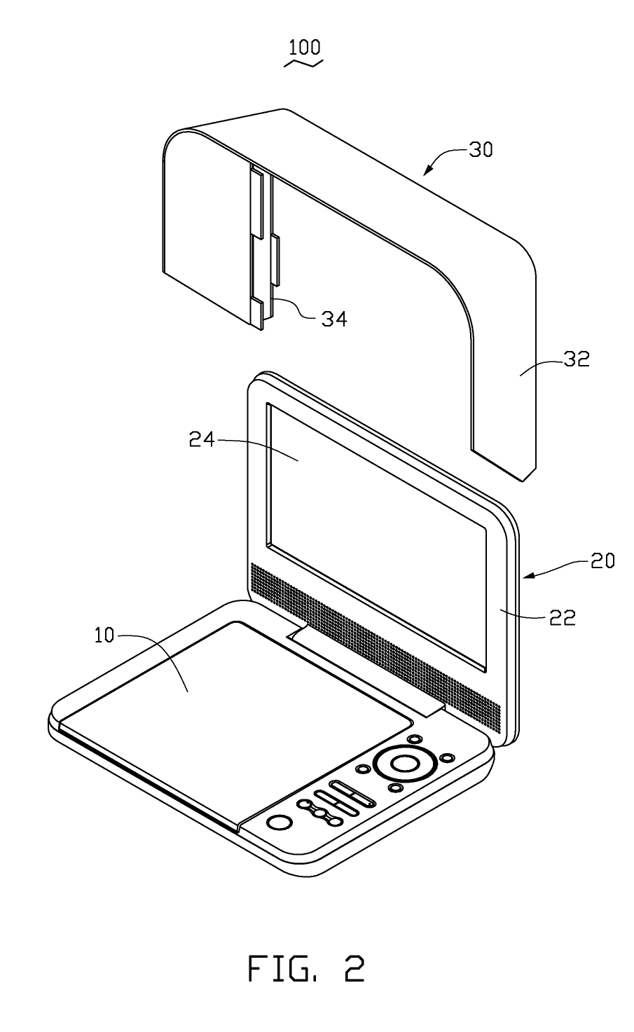

Referring to FIGS. 1 and 2, an electronic device 100 includes a main body 10, a display panel 20 pivotally connected to the main body 10, a light shade 30 detachably attached to the display panel 20. The light shade 30 encloses the display panel 20 except for a side of the display panel 20 connected to the main body 10. In use, the light shade 30 is configured for partially blocking ambient light from the display panel 20.

The display panel 20 is rectangular and includes a casing 22 and a screen 24 received in the casing 22. The casing 22 defines an opening (not labeled) to expose the screen 24. The lower side of the casing 22 is connected to the main body 10.

The light shade 30 includes a shade portion 32 for blocking the ambient light and a positioning portion 34 for attaching the shade portion 32 to the display panel 20. The positioning portion 34 is formed on a side of the shade portion 22. The positioning portion 34 is capable of fastening a left side, an upper side, and a right side of the casing 22 to the light shade 30, such that the shade portion 32 engages with the left side, the upper side, and the right side of the casing 22 to partially block the ambient light.

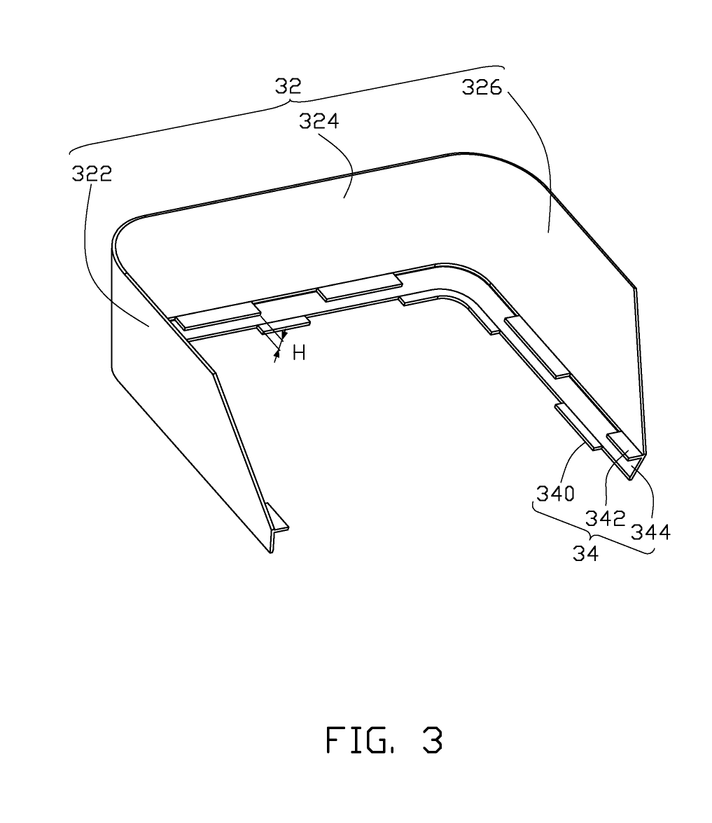

Also referring to FIG. 3, the shade portion 32 includes a left baffle 322, an upper baffle 324, and a right baffle 326 serially connected. That is, the left baffle 322, the upper baffle 324, and the right baffle 326 are configured for engaging with the left side, the upper side, and the right side of the casing 22 respectively. The positioning portion 34 includes a plurality of outer blocks 340, a plurality of inner blocks 342, and a track 344. The plurality of outer blocks 340 and the plurality of inner blocks 342 are staggered and formed on two sides of the track 344. The width H of the track 344 is equal to or slightly wider than a thickness of the casing 22 of the display panel 20.

When the electronic device 100 is used outdoors, the positioning portion 34 is movably attached to the casing 22 from the top side. The plurality of outer blocks 340 and the plurality of inner blocks 342 clamp the left side, the upper side, and the right side of the casing 22. Therefore, the shade portion 32 shades the casing 22 to partially block ambient light from the screen 24, and images or videos displayed in the screen 24 can be viewed clearly.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A light shade for partially blocking ambient light from a display panel, the light shade comprising:
a shade portion for partially blocking the ambient light, the shade portion comprising at least one baffle; and
a positioning portion formed on a side of the shade portion, for attaching the shade portion to the display panel, and the positioning portion comprising a track and a plurality of blocks formed on an inner side and an outer side of the track;
wherein when the shade portion is attached to the display panel, the at least one baffle engages with at least one side of the display panel.

2. The light shade according to claim 1, wherein a part of the plurality of blocks on the inner side of the track are staggered with the other part of the plurality of blocks on the outer side of the track.

3. The light shade according to claim 2, wherein the width of the track is equal to or wider than the thickness of the display panel.

4. The light shade according to claim 1, wherein the shade portion comprises a left baffle, an upper baffle, and a right baffle serially connected.

5. The light shade according to claim 4, wherein the left baffle, the upper baffle, and the right baffle are configured for respectively engaging with a left side, an upper side, and a right side of the display panel.

6. An electronic device comprising:
a display panel; and
a light shade detachably attached to the display panel, the light shade comprising:
a shade portion for partially blocking ambient light from the display panel, the shade portion comprising at least one baffle; and
a positioning portion formed on a side of the shade portion, for attaching the shade portion to the display panel, and the positioning portion comprising a track and a plurality of blocks formed on an inner side and an outer side of the track;
wherein when the shade portion is attached to the display panel, the at least one baffle engages with at least one side of the display panel.

7. The electronic device according to claim 6, wherein the display panel comprises a casing and a screen received in the casing.

8. The electronic device according to claim 7, wherein the casing defines an opening to expose the screen.

9. The electronic device according to claim 8, wherein a part of the blocks on the inner side of the track are staggered with the other part of the blocks on the outer side of the track.

10. The electronic device according to claim 9, wherein the width of the track is equal to the thickness of the casing.

11. The electronic device according to claim 7, wherein the shade portion comprises a left baffle, an upper baffle, and a right baffle serially connected.

12. The light shade according to claim 11, wherein the left baffle, the upper baffle, and the right baffle are configured for respectively engaging with the left side, the upper side, and the right side of the casing.
